(19) United States
(12) Patent Application Publication
(10) Pub. No.: US 2007/0042161 A1
(43) Pub. Date: Feb. 22, 2007

(54) Decay resistant wooden railroad crosstie and method for making same

(75) Inventor: Barrie D. Gibbs, Pittsburgh, PA (US)

Correspondence Address: Jon M. Lewis, Esq., 205 Coulter Building, 231 South Main Street, Greensburg, PA, 15601, US

(73) Assignee: GIBBS GROUP HOLDINGS, INC.

(21) Appl. No.: 11/205,229

(22) Filed: Aug. 16, 2005

(51) Int. Cl. B32B 3/00

(52) U.S. Cl. 428/172; 428/192

(57) ABSTRACT

Protection of wooden articles, such as railroad crossties, against decay or rot is improved through incorporation of borate compounds, such as sodium borate, and a protective coating such as creosote or a resin. Such protection is achieved by placement of a dry borate compound into a hole formed in the wooden article. The hole is then covered, and the borate compound then permitted to migrate and become distributed throughout the wooden article to provide the desired protection. Coating of the thus treated wooden article is conducted either shortly following placement of the borate compound in the hole or at a later convenient time.

### FIELD OF INVENTION

The present invention is directed to an improved method of inoculating wooden products, such as railroad crossties, with borate compounds, such as sodium borate, to reduce or minimize decay and rot of the wood. Creosote or resinous coatings may further serve to protect the wooden crosstie.

### BACKGROUND OF THE INVENTION

The present invention pertains to a method for improving the inoculation of wooden products, such as railroad crossties, pilings, boat docks, decks, porch and patio flooring, fences, telephone poles, and many other wooden products of various cross sections. Such inoculation utilizes a borate compound as an inoculation agent.

The above-mentioned inoculation may be advantageously used in combination with coating processes that provide a protective surface coating to maximize protection of the wooden article from deterioration, such as by decay and rot.

For convenience, the instant invention will be explained and illustrated in terms of wooden railroad crosstie products. Various types of railroad crossties are known in the art. Examples of such railroad crossties are shown in U.S. Pat. Nos. 952,977; 1,036,860; 1,041,736; 1,623,158; and 5,916,932.

The useful life of wooden railroad crossties has long been extended with use of creosote coatings. Crossties coated with creosote eventually split or crack during service, thereby exposing the untreated wooden interior to water with resultant deterioration due to decay and rot.

Coating a wooden core member with a resinous coating and with end caps over the ends of the core member has also extended the useful life of wooden railroad crossties. Such technique is described in U.S. Pat. No. 6,336,265, granted to Niedermair on Jan. 8, 2002, entitled “Composite Railroad Cross Tie and Method of Manufacturing Same.” This patent describes a composite or other type of railroad crosstie for supporting railroad track rails on a ballast or concrete roadbed. The crosstie comprises a wooden core of virgin or recycle natural wood or of man-made, engineered wood such as oriented strand board (OSB), plywood, and the like. The wooden core is coated with virgin or recycled thermoplastic resins, thermosetting resins, and/or rubber. Fillers or reinforcements may optionally be included. During manufacture, the core member is sized to a dimension less than the desired dimension of the finished crosstie to provide space for the coating. End caps are positioned over the ends of the core member; and then a resinous coating is applied to the core member in a continuous process by passing a series of core members, containing end caps, in a substantially end-to-end configuration through a cross head die where a resinous extrudate is coated on the surface of the crosstie.

Although the above-described resinous-coated wooden railroad crosstie constitutes an improvement over uncoated wooden crossties, problems in coating separation from the core member have been encountered. Such separation serves to reduce the useful life of the railroad crosstie because the beneficial effect of the protective coating is minimized, or even lost. The invention described in Applicant's co-pending U.S. patent application Ser. No. 10/970,924 filed Oct. 22, 2004, entitled “Improved Coated Wood Articles and Method of Manufacture” is believed to constitute an improvement to aforesaid U.S. Pat. No. 6,336,265 because it addresses this problem in the art by treating the surface of the core member prior to resin coating to substantially improve coating adhesion and thereby produce a crosstie having an extended useful life. Surface treatments include placing grooves on the surface of the core member and/or driving off moisture from the surface of the core member and/or incising prior to coating the surface of the core member. When used in combination, grooving and incision are normally performed prior to driving off moisture from the surface of the core member, followed by subsequent coating. These techniques serve to significantly improve adhesion between the wooden crosstie and its coating.

Improved end caps having a unique configuration are described in Applicant's above-mentioned co-pending U.S. patent application Ser. No. 10/970,924. These end caps may be placed on the wooden railroad crosstie prior to the above-described continuous resinous coating process. Such end caps fit onto the end of the wooden crosstie in a similar fashion as described in U.S. Pat. No. 6,336,265. However, rather than having a flat outer surface, the end caps of the invention have at least two concentric, lip-like projections on about one-half of the outer surface. The end cap also preferably has a ridge located proximate to the periphery of the outer surface (away from the wood) to permit orientation and indexing of the lips with the opposing end cap when end-to-end railroad crossties are passed through the coating process. Such ridge extends for about half of the periphery and does not extend into the area of the lip. Such structural relationship permits and facilitates indexing. Permitting such outer lips or projections to soften during to heating prior to coating obtains excellent adhesion of the molten coating while protecting the inner lip from softening. This prevents the lips from collapsing against each other. This type of end cap facilitates subsequent cutting apart of crossties made in a continuous process. When end-to-end coating is performed, it is preferred to orient the lip-like projections for each of the consecutive crossties to promote nesting. In this manner, the respective two concentric, lip-like projections that are located on about one-half of the respective outer portion of the end caps nest and thereby form a hollow space between the lips. The hollow space is much more readily separated than the fused solid end caps of U.S. Pat. No. 6,336,265.

Another technique for extending the useful life of wooden railroad crossties comprises treating the crossties with borate compounds, such as sodium borate, as a preservative enhancement of the wood. Such techniques are generally described in an article entitled “Borate Breakthrough” published in the March/April 2005 issue of Crossties. The article describes the pre-treatment of the wooden crosstie with sodium borate followed by standard creosote coating treatment. Following sodium borate pre-treatment, the drying process is said to be impeded for a period of time, and the treated wood is kept from exposure to sun or air and then stacked for air-drying for up to six months. The sodium borate protects the wood from decay during the pre-creosote drying process. Following sufficient drying, creosote coating is applied to the wooden crosstie. The creosote typically penetrates about ¼ to about ½ inch into the interior of the crosstie. The article attributes the success of the preservation process to diffusion or migration of borate into the core of the wooden crosstie as a protection against rot. The creosote treatment is said to provide the final layer of protection, which keeps the borate intact.

Although not specifically mentioned in the Crossties article, it is believed that sodium borate may be applied to the crosstie as an aqueous liquid by spraying, immersing, or dipping. Following such spraying, immersion, or dipping, water evaporates from the surface of the thus treated crosstie, and the borate compound migrates into the wood. It is also believed that penetration of the borate into the wood may be enhanced by pressure, such as may be applied by use of an autoclave.

While leading to improved resistance to decay and rot of the crosstie while in service, the wood eventually dries; and the crosstie becomes cracked or split. This situation permits water, such as rainwater, to enter the crack and cause some of the borate to be leached, thus lessening inoculation effectiveness over a period of time.

The present invention reduces the above-described loss of the protective effect of borate compounds, thus resulting in longer service life. Obviously, an increase in service life is very valuable to the railroad industry by decreasing the overall capital required for crosstie replacement as well as reducing the cost of labor, purchasing, and disposal. A reduction in the volume of crosstie disposal is very desirable because of a reduction in solid waste disposal problems.

As will be described in greater detail below, the method of the invention involves the use of borate compounds, in the form of a solid powder, to provide the desired protection. Such solid borate compounds are placed in one or more holes created in the wooden crosstie and the hole then closed. The borate compound then migrates or diffuses throughout the crosstie due to moisture contained in the crosstie to provide the desired protection. One important advantage of the inventive process is that long crosstie drying times are not required after borate compound application, such as that required following application by an aqueous borate-containing spray. In addition, the amount of borate compound placed in the hole can be selected to be greater than the quantity that becomes initially diffused into the crosstie and seeking a state of saturation. Such excess quantity provides a reservoir of borate compound that can diffuse into the crosstie at a later time to replace any borate compound that has been lost. Such replenishment capability is not found in the above-described prior art and results in longer protection life. Further enhancement of the overall protection of wooden railroad crossties may be obtained by a combination of the borate compound treatment of the invention with various types of protective coatings.

### SUMMARY OF THE INVENTION

The present invention is directed to the inoculation of wooden products, especially wooden railroad crossties, having improved resistance to decay and rot and to methods for making such products. A method for making such products, for example, involves providing an elongated wooden railroad crosstie having a surface area, ends, and at least one hole extending from the surface area into the interior portion of the crosstie. A borate compound, such as solid powdered sodium borate, is then placed in such hole in sufficient quantity so as to be capable of minimizing decay of the crosstie upon subsequent migration from the hole to throughout the crosstie and the hole is then covered in any convenient manner. Once the borate compound migrates throughout the crosstie, potential decay of the wooden crosstie is minimized. The crosstie may be coated immediately or at any convenient time thereafter. Coating materials may include creosote or a resin to further enhance protection of the wooden crosstie from decay.

The intermediate product of the above-described process comprises a wooden product, such as, an elongated wooden railroad crosstie having ends, a coating on its surface, and at least one covered hole extending from the surface area into the interior of the wooden railroad crosstie. The hole contains a sufficient quantity of a solid powdered borate compound to minimize decay of the wooden railroad crosstie upon migration of the borate compound throughout the crosstie.

The resultant product of the process of the present invention comprises the above-described intermediate product wherein the borate compound has been permitted to migrate throughout the wooden railroad crosstie and become distributed therein; and a protective coating, such as creosote or a resin, has been applied to the surface of the wooden railroad crosstie. The useful life of the wooden railroad crossties may be extended further by providing a quantity of solid powdered borate compound in excess of that initially required to minimize decay of the wood in the intermediate product. If the borate compound becomes depleted for various reasons (such as contact with water) during use of the crosstie, additional borate compound is available to migrate into the crosstie to compensate for losses of borate compound.

### DETAILED DESCRIPTION OF THE INVENTION

Although the present invention is applicable to improved protection against decay and rot of a number of wooden articles, the following description is set forth in terms of the treatment of wooden railroad crossties. One skilled in the art will have no difficulty in applying the following description to make and use the invention for other types of wooden articles.

The protection of railroad crossties against decay and rot is improved by the preservation technique of the present invention in combination coating of the crossties. The use of these techniques together maximizes the degree of protection compared with that obtained through use of only one of the techniques and, thus, is believed to result in a state-of-the-art product.

Forming at least one hole in an elongated crosstie may commence protection of wooden railroad crossties. Crossties may be rectangular in cross-section but may have other cross-sectional shapes such as square, oval, diamond, or the like, if desired. Forming of the hole may be performed by, but is not limited to, any convenient means, such as drilling, punching, incising, and the like. The shape of the hole or holes may conveniently be round although other shapes are contemplated. In any event, hole shape is not a critical factor for the performance of the invention.

Once the hole or holes have been formed, a dry borate compound, in plug or powder form, is placed in the hole or holes. The quantity of borate compound is that sufficient to be capable of minimizing decay of the wooden crosstie following migration of the borate compound from the hole to throughout the crosstie. Such migration is possible because of the great affinity of borate compounds for water. In this instance, a sufficient amount of moisture is inherently contained in the wood to permit the provided dry powdered borate compounds to hydrate the moisture content in the wood. Hydration continues until equilibrium/saturation is achieved. Obviously, the amount of moisture contained in the crosstie limits the overall amount of borate compound that can be distributed throughout the crosstie. Thus, undried wood is preferred over dried wood because of its higher moisture content. However, dried wood contains sufficient moisture to allow hydration/migration to occur and thus is suitable for use in the present invention. As will be discussed further below, it is advantageous to add an excess amount of borate compound over that required to achieve the capacity of the crosstie. Following such borate compound inoculation, the crosstie is coated to provide further protection against decay and rot of the wood and to prevent borate compounds from leaching from the wood.

The number of holes placed in the crosstie for subsequent containment of the powdered borate compound is selected to facilitate distribution of the borate compound throughout the crosstie. The size, number, and location of such holes influence the efficiency and effectiveness of the borate compound distribution. Typical hole sizes range from about one-half to about one inch in diameter and are typically six to eight inches in depth. While one hole would be sufficient to obtain inoculation over a long period of time, it is preferred that a multiple number of smaller holes, such as five, be placed over the length of the crosstie to facilitate inoculation or replenishment over a shorter time frame. It is further preferred that two of the multiple holes, each located proximate to under the intended rail position, will be utilized.

A variety of borate compounds may be utilized in the practice of the present invention. Sodium borate (sodium tetraborate decahydrate) is preferred due to its availability and low cost. However, other borate compounds such as potassium borate and other compounds or salts containing borate may be used in the practice of the invention.

As mentioned above, the amount of solid borate compounds placed in the hole or holes in the crosstie is that sufficient to be capable of minimizing decay and rot of the wood. Typically, such amount is about 0.17 pounds of borate compound per cubic foot of wood, with typical amounts ranging from about 0.01 to about 0.30 pounds of borate compound per cubic foot of wood. However, it is preferred to add a quantity of borate compounds in excess of that required to achieve longer protection. The excess amount is then present to replace and augment any amount of borate compound lost during service of the crosstie. Such losses may occur due to contact with rainwater when cracking or splitting of creosote coated crossties occurs and when spikes are driven into such crossties. Should the crosstie be coated with a resin rather than creosote, cracking of the coating and penetration by the spikes can afford an opportunity for the harmful entry of water. However such problems are much less significant for resinous-coated crossties as the water evaporates from the spike holes and borate remains. By adding an excess of borate compound, a reservoir of undistributed borate compound is present for later migration, and consequent protection, into the crosstie. To optimize the useful life of a crosstie, it is preferred to add an excess of at least about 0.20 pounds of borate compound per cubic foot of wood or more to the hole or holes. Any such excess amount is not injurious to the wood or the crosstie product.

Following placement of the borate compound in the hole or holes formed in the crosstie, the hole is covered at the surface of the crosstie. Convenient means for covering the hole include, but are not limited to, a dowel, a lid, a plug, and the like.

Following placement of the solid dry borate compound powder into the hole or holes and then covering the hole or holes, the borate compound migrates throughout the crosstie due to the moisture contained in the crosstie. A protective coating is then placed on the surface of the crosstie, before or after such migration, to further protect the wood from deterioration. Such protective coatings are known in the art and include creosote and resinous coatings.

In the art, wooden railroad crossties, including those containing borate compounds, have long been coated with creosote. Creosote may be applied by well-known techniques including, but not limited to, dipping, immersion, spraying, brushing, roll coating, or preferably under pressure in an autoclave, and the like. Following the application of typical creosote coatings, typical creosote depths of about ¼ to about ½ inch are obtained.

Protective resinous coatings may be applied as a liquid to wooden railroad crossties by spraying, dipping, immersion, brushing, roll coating, extruding and the like. Following such coating, the applied liquid is permitted to cool. Resinous coatings may also be applied by utilizing conventional powder coating techniques which utilize solid particulate resinous coating powders that are typically provided with an electrostatic charge, applied to the surface of the crosstie, and then formed by melting and subsequent cooling, if thermoplastic, or by curing by heat or radiation, if curable. The thickness of suitable resinous coatings typically ranges from about 1/16 to about ½ inch.

Wooden railroad crossties have also been coated with a resin using a continuous end-to-end process in which end caps are first secured on the ends of the wooden railroad crossties and then the crossties are passed in end-to-end configuration through a crosshead die opening where the surface of the crossties is contacted with a molten resinous extrudate and acquire a resinous surface coating. This process extrudes molten resinous extrudate from a distribution passage into the die opening and around the side surfaces of the crosstie to form a coating thereon. Such process is described in greater detail in U.S. Pat. No. 6,336,265, and such patent is incorporated herein by reference.

In the process mentioned in the preceding paragraph, the wooden core is coated with virgin or recycled thermoplastic resins, thermosetting resins, and/or rubber. Fillers or reinforcements may optionally be included. During manufacture, the core member is sized to a dimension less than the desired dimension of the finished crosstie to provide space for the coating. End caps are positioned over the ends of the core member; and then a resinous coating is applied to the core member in a continuous process by passing a series of core members, containing end caps, in a substantially end-to-end configuration through a cross head die where a resinous extrudate is coated on the surface of the crosstie.

An improvement to the coating process described in aforesaid U.S. Pat. No. 6,336,265 is set forth in Applicant's co-pending U.S. patent application Ser. No. 10/970,924 filed Oct. 22, 2004 entitled “Improved Coated Wood Articles and Method of Manufacture.” Such improved technique involves several surface treatments of the wooden railroad crossties to obtain superior adhesion of the resinous coating to the crosstie. Thus, delamination of the resinous coating is reduced and subsequent exposure to harmful water is reduced during service.

The first surface treatment technique involves forming at least one groove on the surface of the wooden crosstie prior to applying a resinous coating to the surface of such grooved crosstie. Groove(s) are preferentially formed along the longitudinal surface(s) of the crosstie. However, grooves placed perpendicular to the longitudinal surface would function to enhance locking of the coating to the surface of the wooden crosstie. A combination of the above-discussed groove orientations is contemplated. Also contemplated is the placement of grooves at various other angular orientations.

When a rectangular shaped wooden crosstie is utilized, grooves may be placed on one or more of the four sides of the crosstie. It is preferred to utilize at least one groove on each of the four sides to maximize enhancement of locking of the coating to the surface of the wooden crosstie.

Groove shapes may include dovetail, square, triangle, truncated triangle, or any other desired shape. A dovetail shape is preferred because the different cross sections of this shape serve to enhance locking of the coating to the crosstie. Dovetail shaped grooves involve a smaller area at the surface of the wooden crosstie and a larger area at the interior of the wooden crosstie. Similarly, triangle or truncated triangle shaped grooves, wherein one tip or surface of the triangle or truncated triangle groove is located at the surface and the larger area located in the interior of the wooden crosstie, may be utilized to further enhance locking.

For example, a longitudinal dovetail groove 3/16 inch at its bottom and ⅛ inch at its top may be utilized. Alternatively, a longitudinal square groove having dimensions of ⅛ inch deep by ⅛ inch wide may be used.

The grooves may be formed on the wooden crosstie by conventional means including hand or machine routing. In particular, a multi-head routing machine with brushes and vacuum to remove wood particles is suitable to form the above-mentioned grooves.

A second surface treatment technique involves reduction in (including the essential removal of) moisture from the surface of the wooden crosstie prior to application of the coating. Such reduction results in excellent binding of the coating to the wooden crosstie and thereby minimizes subsequent delamination or separation of the coating. The wooden crosstie surface may be heated in a conventional heating apparatus, such as a furnace, oven, heater, or the like, for sufficient time and at a temperature to drive off a large portion of the moisture from the surface of the wooden crosstie. Continuous passage of the crosstie through a heating apparatus is preferred because such technique is efficient. It is preferred to drive off essentially all moisture from the surface to maximize adhesion. Oftentimes, the heating will result in a release of moisture in the form of steam from the heated surface, may cause combustion of small portions (such as splinters) of the wooden crosstie, and cause charring of the surface. Typically, heating temperatures in the atmosphere of the furnace or oven of about 800° to about 1,200° F. are sufficient to expel a desired amount of moisture from the surface of the wooden crosstie. Typical heating times ranging from about 1 to about 20 minutes may be utilized, although less than 1 minute or more than 20 minutes may be utilized, depending on the size of the wooden crosstie and travel speed. As would be appreciated by one skilled in the art, the above stated temperatures and times may be further varied when wooden materials having various moisture contents are being treated. Upon exposure to the heated atmosphere of the furnace or oven, the actual surface temperature of the wood is lower than that of the atmosphere but is sufficient to reduce or essentially eliminate the moisture content of the surface of the wood. It is preferred to reduce the moisture content as low as possible to enhance adhesion of the coating to the wooden crosstie.

It is preferred to obtain an essentially moisture-free surface. The essentially moisture-free surface of the wooden crosstie may be characterized as a “case hardened surface.” Such term means that the surface and a shallow depth of the wood have been heated to an extent that such area is essentially moisture free. This case hardened area serves as a seal to prevent moisture from passing from the interior of the wood to its surface to interfere with the bond of the coating and the wooden crosstie, thereby preventing subsequent delamination or separation.

An example of a suitable heating technique is passing the uncoated wooden crosstie through four gas fired infrared heaters, which produce a total of 200,000 BTU's. Such exposure removes essentially all moisture from the surface of the wood and creates a slight charcoaled appearance on the surface.

Exposure for different times and different BTU producing heaters that equal 600,000 BTU's is contemplated, and one skilled in the art would routinely determine specific combinations. For example, 300,000 BTU's could be applied over a 1½ minute time period. Obviously, exposure times may be increased or decreased dependent upon BTU capacity of the heater. It is contemplated that exposure of from about 200,000 to about 800,000 BTU's may be utilized.

A third surface treatment technique involves making incisions in the surface of the wooden crosstie prior to coating the wooden crosstie. Such incision or opening subsequently becomes at least partially filled with resinous coating material to further enhance adhesion. Incising may be performed prior to and/or after grooving and prior to heating to drive off moisture from the surface of the wood. A knife or other sharp object may be exerted against or otherwise forced into the wood to make the incision. However, it is preferred to use a roller having knife-like projections to incise the surface of the wood.

Whether using the process described in U.S. Pat. No. 6,336,265 or that described in Applicant's co-pending U.S. patent application Ser. No. 10/970,924, end caps are secured against the ends of the railroad crosstie. Securing is accomplished by placing peg-like projections of the end cap into holes created in the respective crosstie ends.

The final product produced by the invention contains a sufficient amount of a borate compound, such as sodium borate, distributed throughout the product and coated to provide further protection against degrading of the wood. An excess amount of borate compound is preferably provided to replenish lost borate compound and thereby extend service life. Resinous coatings are preferred because such coatings provide superior protection as contrasted with other coatings that have been used in the art, such as creosote.

It is claimed:

1. A method for making a coated wooden product having improved resistance to decay comprising:
(a) Providing a wooden product having a surface area, ends, and at least one hole extending from said surface area into an interior portion of said wooden product;
(b) Placing a sufficient quantity of a dry borate compound into said hole, said quantity of borate compound capable of minimizing decay of said wooden product following migration of said borate compound from said hole to throughout said wooden product;
(c) Covering the surface area of said wooden product where said hole is located; and
(d) Coating the surface area of said wooden product with a protective coating.

2. The method of claim 1, wherein said borate compound comprises a powder.

3. The method of claim 1, wherein said borate compound comprises a solid plug.

4. The method of claim 1, wherein said wooden product comprises an elongated wooden railroad crosstie.

5. The method of claim 4, wherein said borate compound comprises sodium borate.

6. The method of claim 4, wherein said protective coating comprises a creosote coating.

7. The method of claim 4, wherein said coating comprises a resinous coating.

8. The method of claim 7, wherein said coating step comprises securing end caps on said ends of said elongated wooden railroad crosstie and then continuously passing a series of wooden railroad crossties in substantially end-to-end configuration through a crosshead die opening and contacting said wooden railroad crossties with a molten resinous extrudate in said die opening to form a resinous coating on the surface of said wooden railroad crossties.

9. The method of claim 4, wherein said wooden railroad crosstie has at least five holes.

10. The method of claim 4, wherein said quantity of borate compound is at least about 0.01 to about 0.30 pounds of borate compound per cubic foot of wood.

11. The method of claim 4, wherein said quantity of borate compound is in excess of that required to minimize decay of said wooden member.

12. The method of claim 11, wherein said excess quantity of borate compound is at least about 0.20 pounds of borate compound per cubic foot of wood.

13. A wooden product having improved resistance to decay comprising a wooden product having a coating on a surface area, ends, and at least one hole extending from said surface area into an interior of said wooden product, said hole containing a sufficient quantity of a dry borate compound to minimize decay of said wooden product upon migration and distribution of said borate compound from said hole to throughout and within said wooden product, said hole being covered at said surface area.

14. The method of claim 13, wherein said borate compound comprises a solid plug.

15. The method of claim 13, wherein said borate comprises a powder.

16. The wooden product of claim 13, wherein said wooden product comprises an elongated wooden railroad crosstie.

17. The wooden railroad crosstie of claim 16, wherein solid borate compound is distributed within said wooden railroad crosstie and said wooden railroad crosstie is coated with a protective coating.

18. The wooden railroad crosstie of claim 16, wherein said borate compound comprises sodium borate.

19. The wooden railroad crosstie of claim 17, wherein said protective coating comprises a creosote coating.

20. The wooden railroad crosstie of claim 17, wherein said protective coating comprises a resinous coating.

21. The wooden railroad crosstie of claim 20, further comprising caps secured over said ends of said wooden railroad crosstie.

22. The wooden railroad crosstie of claim 16, wherein said wooden member has at least five holes.

23. The wooden railroad crosstie of claim 16, wherein said quantity of borate compound is at least about 0.01 to about 0.30 pounds of borate compound to per cubic foot of wood.

24. The wooden railroad crosstie of claim 16, wherein said quantity borate compound is in excess of that required to minimize decay of said wooden member.

25. The wooden railroad crosstie of claim 20, wherein said excess quantity of borate compound is at least about 0.20 pounds of borate compound per cubic foot of wood.
